(19) United States
(12) Patent Application Publication
(10) Pub. No.: US 2026/0079440 A1
(43) Pub. Date: Mar. 19, 2026

(54) FIXING DEVICE AND IMAGE FORMING APPARATUS

(71) Applicant: BROTHER KOGYO KABUSHIKI KAISHA, Nagoya (JP)

(72) Inventors: Shota Iriyama, Tokoyama (JP); Shuji Kawasaki, Nagoya (JP)

(21) Appl. No.: 19/327,225

(22) Filed: Sep. 12, 2025

(30) Foreign Application Priority Data
Sep. 17, 2024 (JP) 2024-160432

(51) Int. Cl. G03G 21/16; G03G 15/20

(52) U.S. Cl. CPC G03G 21/1652; G03G 15/2028; G03G 15/2039; G03G 15/2064; G03G 2221/1639

(57) ABSTRACT

A fixing device is installable into a main housing of an image forming apparatus and includes a heating rotator, a pressure rotator, a first temperature sensor, a second temperature sensor, an external connector, an intermediate circuit board, a first side frame, a second side frame, and a connecting frame. The heating rotator includes a heater. The pressure rotator nips a sheet in combination with the heating rotator. The external connector is connectable to a main housing connector of the main housing. The intermediate circuit board is configured to relay signals from the first temperature sensor and the second temperature sensor to the external connector. The connecting frame connects the first side frame and the second side frame. The connecting frame is made of metal and is connected to a ground of the main housing. The ground of the intermediate circuit board is electrically continuous with the connecting frame.

### REFERENCE TO RELATED APPLICATIONS

This application claims priority from Japanese Patent Application No. 2024-160432 filed on Sep. 17, 2024. The entire contents of the priority application is incorporated herein by reference.

### BACKGROUND ART

A fixing device known in the art, which is installable into a main housing of an image forming apparatus, includes a plurality of temperature sensors, an external connector, and an intermediate circuit board. The external connector is connectable to a main housing connector of the image forming apparatus. The intermediate circuit board relays signals from the temperature sensors to the external connector.

### SUMMARY

The temperature sensors connected to the intermediate circuit board are susceptible to failure if an electrostatic discharge occurs between the external connector and the main housing connector when the fixing device is installed into the main housing.

It would be desirable to restrain such failure of the temperature sensors.

In one aspect, a fixing device installable into a main housing of an image forming apparatus is disclosed herein.

The fixing device, includes a heating rotator, a pressure rotator, a first temperature sensor, a second temperature sensor, an external connector, an intermediate circuit board, a first side frame, a second side frame, and a connecting frame.

The heating rotator extends in a longitudinal direction and includes a heater.

The pressure rotator extends in the longitudinal direction and nips a sheet in combination with the heating rotator.

The first temperature sensor detects a temperature of the heating rotator.

The second temperature sensor detects a temperature of the heating rotator. The second temperature sensor is located at a position different from a position at which the first temperature sensor is located in the longitudinal direction.

The external connector is connectable to a main housing connector of the main housing.

The intermediate circuit board relays a signal from the first temperature sensor to the external connector, and relays a signal from the second temperature sensor to the external connector.

The first side frame is located on one side in the longitudinal direction with respect to the heating rotator.

The second side frame is located on the other side in the longitudinal direction with respect to the heating rotator.

The connecting frame connects the first side frame and the second side frame. The connecting frame is made of metal. The connecting frame is connected to a ground of the main housing.

A ground of the intermediate circuit board is electrically continuous with the connecting frame.

Since the ground of the intermediate circuit board is electrically continuous with the connecting frame that is connected to the ground of the main housing, static electricity can be dissipated via the connecting frame if an electrostatic discharge occurs between the external connector and the main housing connector when the fixing device is installed into the main housing. Failure of the temperature sensors can thereby be restrained.

The external connector may include a first ground terminal, and the main housing connector may include a second ground terminal connected to the ground of the main housing.

The first ground terminal may be connected to the ground of the main housing via the second ground terminal in a state where the external connector is attached to the main housing connector.

Since the first ground terminal is connected to the ground of the main housing via the second ground terminal in the state where the external connector is attached to the main housing connector, the intermediate circuit board can be connected to the ground of the main housing via the connectors after the external connector and the main housing connector are attached.

The external connector may include another terminal in addition to the first ground terminal.

The first ground terminal may protrude further downstream than the another terminal, in a direction in which the external connector is moved relative to the main housing connector to be attached thereto.

Since the first ground terminal protrudes further downstream than the another terminal, in the direction in which the external connector is moved relative to the main housing connector to be attached thereto, static electricity can be dissipated from the first ground terminal to the connecting frame if an electrostatic discharge occurs between the external connector and the main housing connector when the fixing device is installed into the main housing. Failure of the temperature sensors can thereby be restrained.

The fixing device may further include a helical compression spring.

The helical compression spring establishes electrical continuity between the ground of the intermediate circuit board and the connecting frame. The helical compression spring is disposed between the intermediate circuit board and the connecting frame.

Since the helical compression spring, which establishes electrical continuity between the ground of the intermediate circuit board and the connecting frame, is disposed between the intermediate circuit board and the connecting frame, electrical continuity between the ground of the intermediate circuit board and the connecting frame can be stabilized.

The fixing device may further include a plastic frame and a screw, and the intermediate circuit board may be elongated in the longitudinal direction. The intermediate circuit board has a first end portion on the one side in the longitudinal direction and a second end portion on the other side in the longitudinal direction.

The plastic frame is disposed between the intermediate circuit board and the connecting frame.

The screw fixes the intermediate circuit board to the plastic frame.

The plastic frame includes a hook engaged with the first end portion of the intermediate circuit board.

The screw fixes the second end portion of the intermediate circuit board to the plastic frame.

Since the plastic frame includes a hook engaged with the first end portion of the intermediate circuit board and screw fixes the second end portion of the intermediate circuit board to the plastic frame, the intermediate circuit board can be easily fixed to the plastic frame.

The helical compression spring may be located between the hook and the screw in the longitudinal direction.

A distance from the screw to the helical compression spring may be shorter than a distance from the helical compression spring to a central portion of the intermediate circuit board in the longitudinal direction.

Since the helical compression spring is located between the hook and the screw and the distance from the screw to the helical compression spring is shorter than a distance from the helical compression spring to a central portion of the intermediate circuit board in the longitudinal direction, the helical compression spring can be compressed while restraining the intermediate circuit board from deflecting when the intermediate circuit board is fixed to the plastic frame by the screw.

The helical compression spring may include a coil and an arm extending from an end of the coil located closer to the intermediate circuit board.

The arm may be engaged with the plastic frame to restrict rotation of the helical compression spring.

Since the arm of the helical compression spring is engaged with the plastic frame to restrict rotation of the helical compression spring, electrical continuity between the ground of the intermediate circuit board and the helical compression spring can be stabilized.

The fixing device may further include a contacting portion.

The contacting portion contacts the main housing and establishes electrical continuity with the ground of the main housing in a state where the fixing device is installed in the main housing. The contacting portion is electrically continuous with the connecting frame.

Since the contacting portion, which contacts the main housing and establishes electrical continuity with the ground of the main housing in the state where the fixing device is installed in the main housing, is electrically continuous with the connecting frame, continuity between the connecting frame and the ground of the main housing can be established via the contacting portion.

The contacting portion may be a boss extending in the longitudinal direction.

Since the contacting portion is a boss extending in the longitudinal direction, the fixing device and the main housing can be easily brought into contact.

The first side frame may be made of metal, and the boss may be fixed to the first side frame.

Since the boss is fixed to the first side frame that is made of metal, electrical continuity between the intermediate circuit board and the ground of the main housing can be established via the connecting frame, the first side frame and the boss.

When the fixing device is being installed into the main housing, the contacting portion may contact the main housing and establish electrical continuity with the ground of the main housing before the external connector is attached to the main housing connector.

Since the connecting portion contacts the main housing before the external connector is attached to the main housing connector, static electricity can be more reliably dissipated via the connecting frame if an electrostatic discharge occurs between the external connector and the main housing connector when the fixing device is installed into the main housing. Failure of the temperature sensors can thereby be further restrained.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is a cross-sectional view showing an image forming apparatus.

FIG. 2 is a perspective view showing a fixing device and a main housing of the image forming apparatus with a rear cover open.

FIG. 3 is a perspective view of the fixing device showing a side of the fixing device on which an external connector is located.

FIG. 4 is an illustration showing the fixing device, and a guide surface, a first recess and a second recess of the main housing.

FIG. 5 is a perspective view of the fixing device showing a first side frame, a second side frame, a connecting frame, a first temperature sensor, a second temperature sensor, and an intermediate circuit board.

FIG. 6 is a schematic circuit diagram showing electrical connections of the fixing device and the main housing.

FIG. 7 is a perspective view of the fixing device showing a plastic frame and a screw.

FIG. 8 is a partial exploded perspective view of the fixing device showing the plastic frame, the intermediate circuit board, the screw, and a helical compression spring.

FIG. 9 is a partial view of the fixing device as viewed in a second direction showing the intermediate circuit board and the helical compression spring.

FIG. 10 is a cross-sectional view taken along line X-X of FIG. 9.

FIG. 11A is a perspective view of the helical compression spring.

FIG. 11B is an enlarged view of a part of FIG. 9.

FIGS. 12A and 12B are illustrations showing the external connector and the main housing connector.

FIGS. 13A and 13B are illustrations for explaining steps of installing the fixing device into the main housing.

FIGS. 14A and 14B are illustrations for explaining steps of installing the fixing device into the main housing, following the steps shown in FIGS. 13A and 13B.

### DESCRIPTION

An embodiment of the present disclosure will be described in detail referring to the drawings where appropriate.

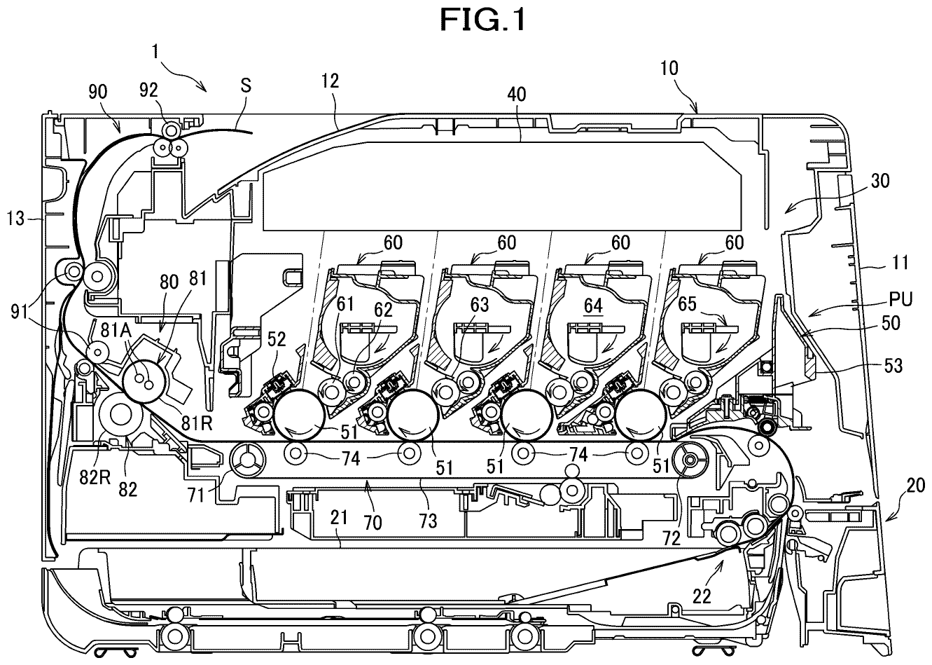

As shown in FIG. 1, an image forming apparatus 1 comprises a main housing 10, a sheet feeder unit 20, an image forming unit 30, a fixing device 80, and a sheet ejection unit 90.

The main housing 10 comprises a front cover 11, an output tray 12, and a rear cover 13. The front cover 11 covers and uncovers an opening formed on the front side of the main housing 10. The rear cover 13 covers and uncovers an opening formed on the rear side of the main housing 10.

The sheet feeder unit 20 comprises a sheet tray 21 and a feeding mechanism 22. The sheet tray 21 contains sheets S of paper or the like. The feeding mechanism 22 feeds the sheets S in the sheet tray 21 to the image forming unit 30.

The image forming unit 30 comprises an exposure device 40, a process unit PU, and a transfer unit 70.

The exposure device 40 is located above the process unit PU. The exposure device 40 emits light beams, as shown by dash-dotted lines, to expose surfaces of photosensitive drums 51.

The process unit PU is located between the sheet tray 21 and the exposure device 40. The process unit PU is installable into and removable from the main housing 10 through the opening of the main housing 10, which is uncovered when the front cover 11 is opened. The process unit PU comprises a drum cartridge 50 and a plurality of toner cartridges 60.

The drum cartridge 50 comprises a plurality of photosensitive drums 51, a plurality of chargers 52 each corresponding to one of the photosensitive drums 51, and a drum frame 53. The drum frame 53 supports the photosensitive drums 51 and the chargers 52. The drum frame 53 is movably supported by the main housing 10. The toner cartridges 60 are installable onto and removable from the drum frame 53.

The plurality of toner cartridges 60 each contains toner of a different color. Each toner cartridge 60 comprises a development roller 61, a supply roller 62, a doctor blade 63, a toner containing unit 64 that contains toner, and an agitator 65. The agitator 65 agitates toner in the toner containing unit 64. The agitator 65 supplies toner to the supply roller 62. The supply roller 62 supplies toner to the development roller 61. The doctor blade 63 adjusts the thickness of toner on the development roller 61 to a uniform thickness.

The transfer unit 70 is located between the sheet tray 21 and the process unit PU. The transfer unit 70 comprises a drive roller 71, a follower roller 72, a conveyor belt 73, and a plurality of transfer rollers 74. The conveyor belt 73 is an endless belt for conveying each sheet S. The drive roller 71 and the follower roller 72 cause the conveyor belt 73 to rotate. The transfer rollers 74 face an inner surface of the conveyor belt 73. The conveyor belt 73 is sandwiched between the transfer rollers 74 and the photosensitive drums 51.

The fixing device 80 comprises a heating member 81 and a pressure member 82. The heating member 81 comprises a heating roller 81R as an example of a heating rotator and a heater 81A. The heating roller 81R heats the sheet S. The heater 81A is disposed in the heating roller 81R. The heating roller 81R receives a driving force from a driving source (not shown) and rotates. The pressure member 82 comprises a pressure roller 82R as an example of a pressure rotator. The pressure roller 82R nips the sheet S in combination with the heating roller 81R. The pressure roller 82R is driven by the heating roller 81R and rotates.

The chargers 52 charge the respective surfaces of the photosensitive drums 51. The exposure device 40 exposes the surfaces of the photosensitive drums 51, which are charged by the chargers 52, by light beams. Electrostatic latent images are thereby formed on the photosensitive drums 51. The development rollers 61 supply toner to the respective photosensitive drums 51 on which the electrostatic latent images are formed. Toner images are thereby formed on the photosensitive drums 51.

The photosensitive drums 51 and the transfer rollers 74 convey the sheet S fed from the sheet feeder unit 20, and thereby transfer the toner images formed on the photosensitive drums 51 onto the sheet S. The fixing device 80 conveys the sheet S on which the toner images are transferred, by the heating roller 81R and the pressure roller 82R, and thereby fixes the toner images on the sheet S.

The sheet ejection unit 90 comprises conveyor rollers 91 and an ejection roller 92. The conveyor rollers 91 convey the sheet S to the ejection roller 92. The ejection roller 92 ejects the sheet S onto the output tray 12.

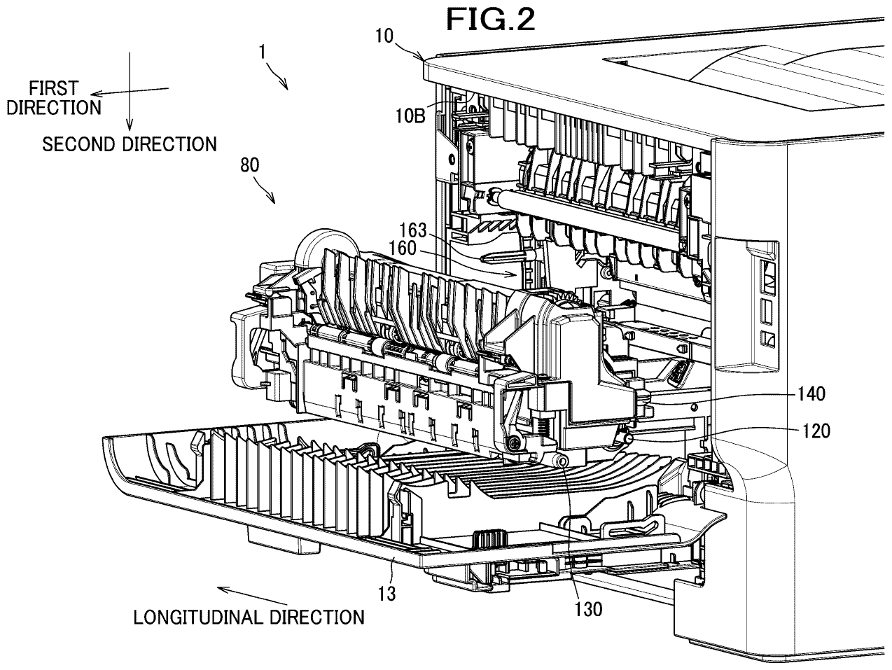

As shown in FIG. 2, the fixing device 80 is installable into the main housing 10 of the image forming apparatus 1. In more detail, the fixing device 80 is installable into the main housing 10 through the opening 10B, which is uncovered when the rear cover 13 is opened. In the following description, directions will be described using longitudinal direction, first direction, and second direction shown in FIG. 2.

The longitudinal direction is the longitudinal direction of the heating roller 81R. The heating roller 81R and the pressure roller 82R both extend in the longitudinal direction. In this embodiment, the longitudinal direction is a direction along a lateral direction of the image forming apparatus 1. One side in the longitudinal direction corresponds to the right side of the image forming apparatus 1, and the other side in the longitudinal direction corresponds to the left side of the image forming apparatus 1.

The first direction is a direction along an installation direction in which the fixing device 80 is installed into the main housing 10. The first direction is a direction that crosses the longitudinal direction. In this embodiment, the first direction is perpendicular to the longitudinal direction. The first direction is a direction along a front-rear direction of the image forming apparatus 1. One side in the first direction corresponds to the rear side of the image forming apparatus 1, and the other side in the first direction corresponds to the front side of the image forming apparatus 1. The fixing device 80 is installable into the main housing 10 from one side toward the other side in the first direction.

The second direction is a direction that crosses the longitudinal direction and the first direction. In this embodiment, the second direction is perpendicular to the longitudinal direction and to the first direction. The second direction is a direction along the up-down direction of the image forming apparatus 1. One side in the second direction corresponds to the downward side of the image forming apparatus 1, and the other side in the second direction corresponds to the upward side of the image forming apparatus 1.

The arrows showing the directions in the drawings point to the one side in each direction.

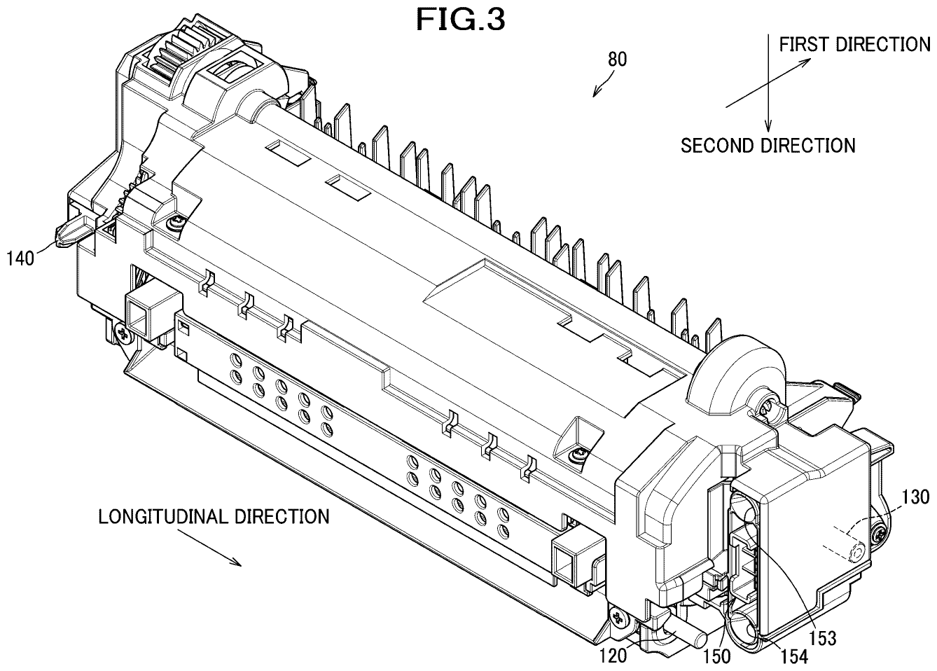

As shown in FIGS. 2 and 3, the fixing device 80 has a first longitudinal end portion on the one side in the longitudinal direction and a second longitudinal end portion on the other side in the longitudinal direction. The fixing device 80 further has a first lateral end portion on the one side in the first direction and a second lateral end portion on the other side in the first direction. The fixing device 80 comprises a pair of first bosses 120 as an example of a contacting portion, a pair of second bosses 130, a protrusion 140, and an external connector 150. The image forming apparatus 1 further comprises a main housing connector 160.

The first bosses 120 are parts that contact the main housing 10 and are thereby located in place relative to the main housing 10 in the first direction and in the second direction in a state where the fixing device 80 is installed in the main housing 10. The first bosses 120 have cylindrical shapes. The first bosses 120 extend in the longitudinal direction. The first bosses 120 are respectively located at the first longitudinal end portion and the second longitudinal end portion of the fixing device 80. The first bosses 120 have symmetrical structures with respect to a plane perpendicular to the longitudinal direction. The first bosses 120, as the contacting portion, are examples of a “boss”.

The second bosses 130 are parts that contact the main housing 10 to stop the rotation of the fixing device 80 about the first bosses 120 in the state where the fixing device 80 is installed in the main housing 10. The second bosses 130 have hollow cylindrical shapes. The second bosses 130 are located further to the one side in the first direction than the first bosses 120. The second bosses 130 are located further to the one side in the second direction than the first bosses 120. The second bosses 130 extend in the longitudinal direction. The second bosses 130 are respectively located at the first longitudinal end portion and the second longitudinal end portion of the fixing device 80. The second bosses 130 have symmetrical structures with respect to a plane perpendicular to the longitudinal direction.

The protrusion 140 is located at the second lateral end portion of the fixing device 80. The protrusion 140 is located at the second longitudinal end portion of the fixing device and protrudes toward the other side in the first direction. The cross section of the protrusion 140, perpendicular to the first direction, is shaped as a cross. An end portion of the protrusion 140 on the other side in the first direction is narrower than an end portion of the protrusion 140 on the one side in the first direction.

The external connector 150 is connectable to the main housing connector 160 of the main housing 10. The external connector 150 is attached to the main housing connector 160 in the state where the fixing device 80 is installed in the main housing 10. The external connector 150 is located at the first longitudinal end portion of the fixing device 80. The main housing connector 160 is a floating connector held by the main bousing 10 in a manner movable relative to the main housing 10. When the main housing connector 160 and the external connector 150 are attached, electricity is, for example, suppliable to the heater 81A disposed in the heating roller 81R.

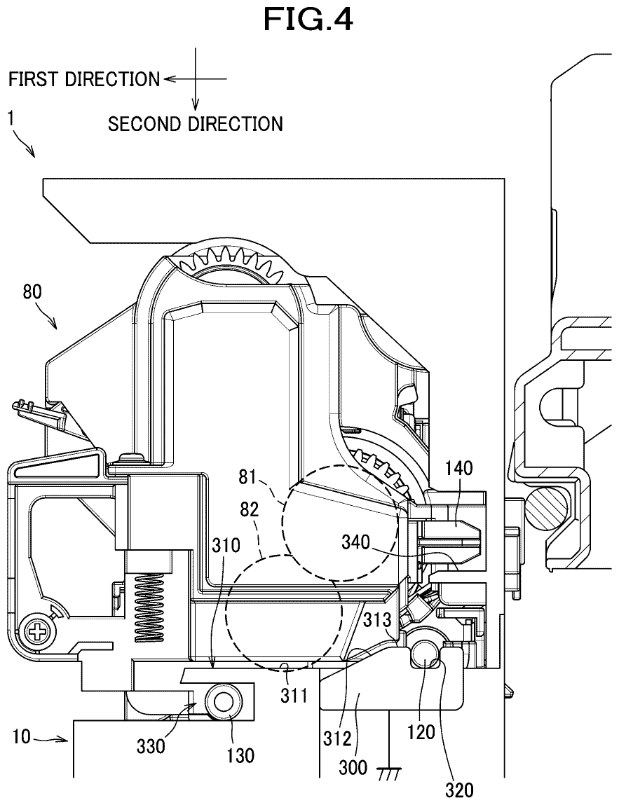

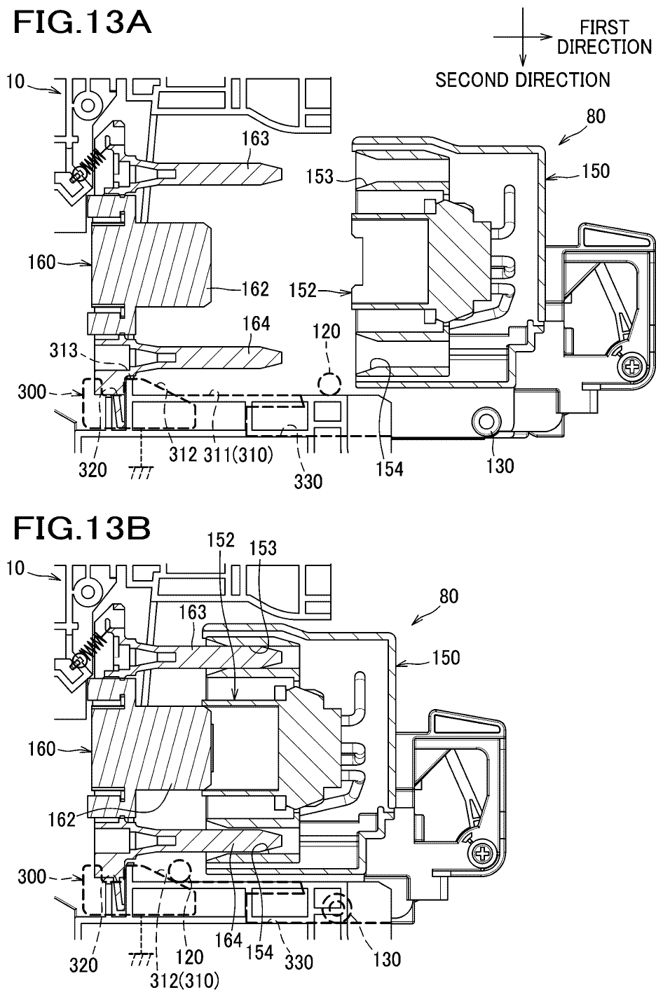

As shown in FIG. 4, the main housing 10 has a guide surface 310, a first recess 320, and a second recess 330 on each side of the fixing device 80 in the longitudinal direction (see also FIG. 13A). The guide surfaces 310, the first recesses 320, and the second recesses 330 have symmetrical structures with respect to a plane perpendicular to the longitudinal direction.

The first recesses 320 are recessed toward the one side in the second direction. Each of the first bosses 120 of the fixing device 80 is located in the corresponding one of the first recesses 320 in the state where the fixing device 80 is installed in the main housing 10. The main housing 10 comprises a metal plate 300 on each side of the fixing device 80 in the longitudinal direction. Each of the first recesses 320 is formed in the corresponding one of the metal plates 300. The metal plates 300 are connected to the ground of the main housing 10.

The first bosses 120 are made of metal. Specifically, the first bosses are made of metal rods. Each of the first bosses 120 contacts the corresponding one of the metal plates 300 of the main housing 10 and is thereby electrically continuous with the ground of the main housing 10 in the state where the fixing device 80 is installed in the main housing 10. In this embodiment, when the fixing device 80 is being installed into the main housing 10, each of the first bosses 120 contact the corresponding one of the metal plates 300 and is thereby electrically continuous with the ground of the main housing 10 before the external connector 150 is connected to the main housing connector 160.

Each of the guide surfaces 310 guides the corresponding one of the first bosses 120 toward the recess 320 when the fixing device 80 is being installed into the main housing 10. Each guide surface 310 includes a first guide surface 311, a second guide surface 312, and a third guide surface 313.

The first guide surface 311 extends in the first direction.

The second guide surface 312 and the third guide surface 313 are formed on the corresponding one of the metal plates 300. The second guide surface 312 is located between the first guide surface 311 and the corresponding one of the first recesses 320. Specifically, the second guide surface 312 is located between the first guide surface 311 and the third guide surface 313. The second guide surface 312 is inclined diagonally upward such that an edge of the second guide surface 312 on the one side in the first direction is located further to the one side in the second direction than an edge of the second guide surface 312 on the other side in the first direction.

The third guide surface 313 is located between the second guide surface 312 and the first recess 320. The third guide surface 313 extends from an edge of the second guide surface 312 on the other side in the first direction toward the other side in the first direction.

The second recesses 330 are recessed toward the other side in the first direction. Each of the second bosses 130 is located in the corresponding one of the second recesses 330 in the state where the fixing device 80 is installed in the main housing 10.

The main housing 10 has a slotted hole 340. The slotted hole 340 is a blind hole elongated in the second direction. The slotted hole 340 is recessed toward the other side in the first direction. The slotted hole 340 receives the protrusion 140 in the state where the fixing device 80 is installed in the main housing 10. The fixing device 80 is located in place in the longitudinal direction when the protrusion 140 is received in the slotted hole 340.

The dimension of the slotted hole 340 in the longitudinal direction is approximately the same as the dimension of the protrusion 140 in the longitudinal direction. The protrusion 140 fits into the slotted hole 340 in the longitudinal direction. The slotted hole 340 restricts the protrusion 140 from moving in the longitudinal direction. The slotted hole 340 thereby restricts the fixing device 80 from moving in the longitudinal direction. The dimension of the slotted hole 340 in the second direction is larger than the dimension of the protrusion 140 in the second direction.

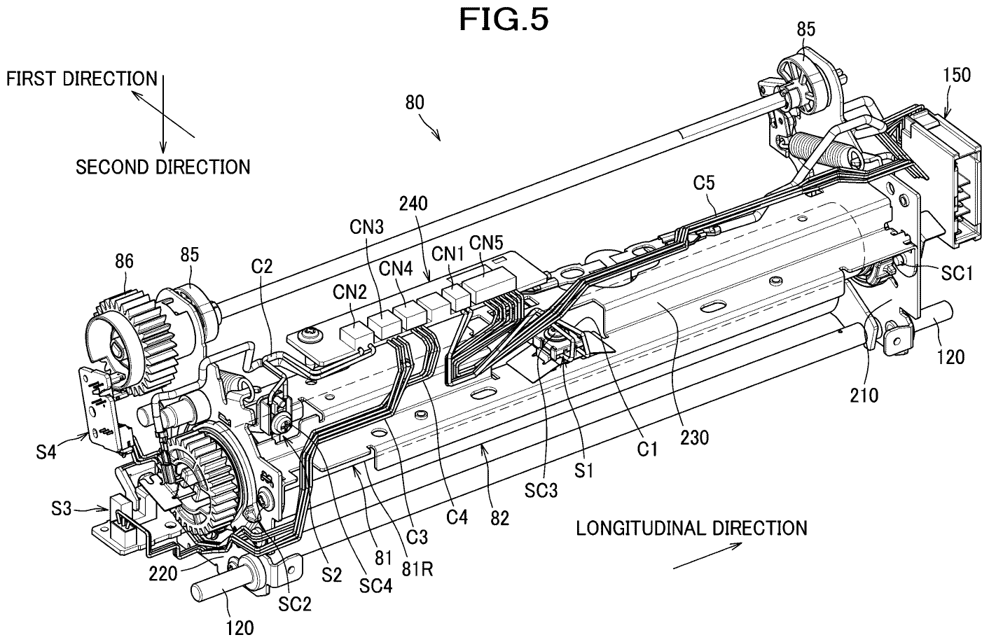

As shown in FIG. 5, the fixing device 80 comprises a first side frame 210, a second side frame 220, a connecting frame 230, a first temperature sensor S1, a second temperature sensor S2, a sheet sensor S3, a cam sensor S4, and an intermediate circuit board 240.

The first side frame 210, the second side frame 220, and the connecting frame 230 are metal frames. Specifically, the first side frame 210, the second side frame 220, and the connecting frame 230 are made of sheet metal.

The first side frame 210 is located on the one side in the longitudinal direction with respect to the heating roller 81R. The first side frame 210 supports one end portion of the heating roller 81R on the one side in the longitudinal direction. The first boss 120 located on the one side in the longitudinal direction is fixed to the first side frame 210. In this embodiment, the first boss 120 located on the one side in the longitudinal direction is fixed to the first side frame 210 by calking.

The second side frame 220 is located on the other side in the longitudinal direction with respect to the heating roller 81R. The second side frame 220 supports the other end portion of the heating roller 81R on the other side in the longitudinal direction. The first boss 120 located on the other side in the longitudinal direction is fixed to the second side frame 220. In this embodiment, the first boss 120 located on the other side in the longitudinal direction is fixed to the second side frame 220 by calking.

The connecting frame 230 connects the first side frame 210 and the second side frame 220. The connecting frame 230 extends in the longitudinal direction. One end portion of the connecting frame 230 on the one side in the longitudinal direction is fixed to the first side frame 210 by a screw SC1. The other end portion of the connecting frame 230 on the other side in the longitudinal direction is fixed to the second side frame 220 by a screw SC2.

The first bosses 120 are electrically continuous with the connecting frame 230 via the first side frame 210 or the second side frame 220. The connecting frame 230 is connected to the ground of the main housing 10 via the first side frame 210 or the second side frame 220, one of the first bosses 120, and one of the metal plates 300 (see FIG. 4) of the main housing 10 in the state where the fixing device 80 is installed in the main housing 10.

The first temperature sensor S1 and the second temperature sensor S2 detect temperatures of the heating member 81. Specifically, the first temperature sensor S1 and the second temperature sensor S2 detect temperatures of the heating roller 81R.

The first temperature sensor S1 is, for example, a non-contact type thermistor. The first temperature sensor S1 is fixed to the connecting frame 230 by a screw SC3. The first temperature sensor S1 is spaced apart from a surface of the heating roller 81R. The first temperature sensor S1 is opposed to the vicinity of a central portion of the heating roller 81R in the longitudinal direction.

The second temperature sensor S2 is, for example, a contact type thermistor. The second temperature sensor S2 is fixed to the connecting frame 230 by a screw SC4. The second temperature sensor S2 is disposed in contact with the surface of the heating roller 81R. The second temperature sensor S2 is located in a position different from that of the first temperature sensor S1 in the longitudinal direction. Specifically, the second temperature sensor S2 is opposed to an end portion of the heating roller 81R on the other side in the longitudinal direction.

The sheet sensor S3 is a sensor for detecting whether there is a sheet S between the heating roller 81R and the pressure roller 82R. The sheet sensor S3 comprises, for example, an actuator that swings upon contact with a sheet S passing through between the heating roller 81R and the pressure roller 82R and an optical sensor that detects the swinging of the actuator.

The cam sensor S4 is a sensor for detecting the phase of cams 85. The fixing device 80 comprises the cams 85 and a cam gear 86. The cams 85 rotate to thereby change the nip pressure between the heating roller 81R and the pressure roller 82R. The cam gear 86 is a gear that receives a driving force from a drive source (not shown) and causes the cams 85 to rotate. The cam sensor S4 is, for example, an optical sensor. The cam sensor S4 detects the phase of the cam gear 86 to thereby detect the phase of the cams 85. In the image forming apparatus 1, the cam sensor S4 detects the phase of the cams 85, which allows the nip pressure between the heating roller 81R and the pressure roller 82R to be determined.

The intermediate circuit board 240 is elongated in the longitudinal direction. The intermediate circuit board 240 has a first end portion on one side in the longitudinal direction and a second end portion on the other side in the longitudinal direction. The intermediate circuit board 240 relays signals from the first temperature sensor S1 to the external connector 150 and relays signals from the second temperature sensor S2 to the external connector 150. Further, the intermediate circuit board 240 relays signals from the sheet sensor S3 to the external connector 150 and relays signals from the cam sensor S4 to the external connector 150.

The intermediate circuit board 240 comprises a first temperature sensor connector CN1, a second temperature sensor connector CN2, a sheet sensor connector CN3, a cam sensor connector CN4, and a relay connector CN5. The connectors CN1 to CN5 are examples of internal connectors provided on the intermediate circuit board 240. The intermediate circuit board 240 is connected to the first temperature sensor S1 by a first cable C1 extending from the first temperature sensor S1 and connected to the first temperature sensor connector CN1.

The intermediate circuit board 240 is connected to the second temperature sensor S2 by a second cable C2 extending from the second temperature sensor S2 and connected to the second temperature sensor connector CN2. The intermediate circuit board 240 is connected to the sheet sensor S3 by a third cable C3 extending from the sheet sensor S3 and connected to the sheet sensor connector CN3.

The intermediate circuit board 240 is connected to the cam sensor S4 by a fourth cable C4 extending from the cam sensor S4 and connected to the cam sensor connector CN4. The intermediate circuit board 240 is connected to the external connector 150 by a fifth cable C5 extending from the external connector 150 and connected to the relay connector CN5.

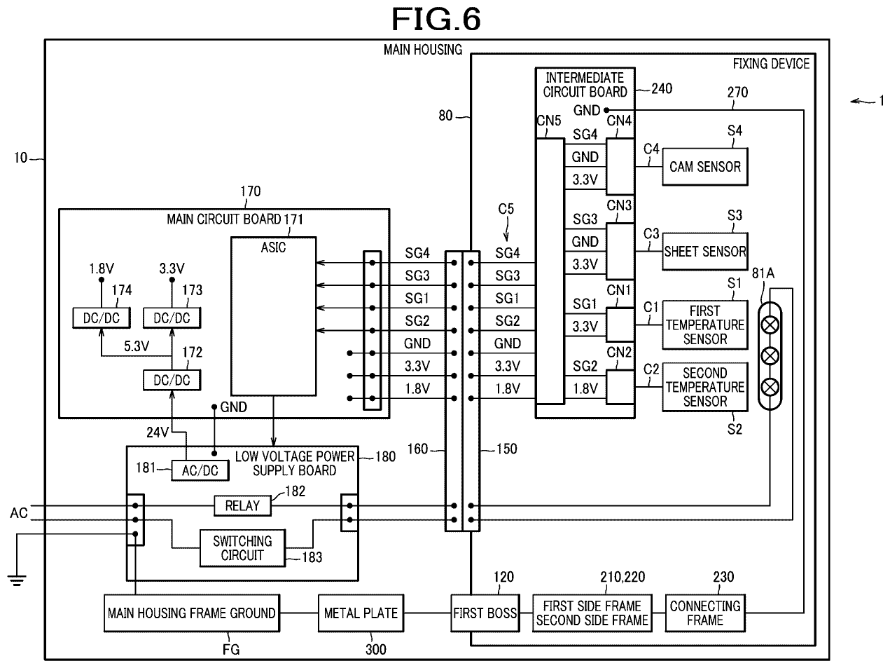

As shown in FIG. 6, the image forming apparatus 1 further comprises a main circuit board 170 and a low voltage power supply board 180. The main circuit board 170 and the low voltage power supply board 180 is disposed in the main housing 10.

The main circuit board 170 controls the fixing device 80. The main circuit board 170 comprises an Application Specific Integrated Circuit (ASIC) 171 and a plurality of DC/DC convertors 172 to 174. The DC/DC convertor 172 converts a direct voltage (24V) supplied from the low voltage power supply board 180 to a predetermined direct voltage (5.3V) and outputs the predetermined direct voltage (5.3V). The DC/DC convertor 173 converts the direct voltage (5.3V) supplied from the DC/DC convertor 172 to a predetermined direct voltage (3.3V) and outputs the predetermined direct voltage (3.3V). The DC/DC convertor 174 converts the direct voltage (5.3V) supplied from the DC/DC convertor 172 to a predetermined direct voltage (1.8V) and outputs the predetermined direct voltage (1.8V).

The low voltage power supply board 180 outputs electric power to the fixing device 80 and the main circuit board 170. The low voltage power supply board 180 comprises an AC/DC convertor 181, a relay 182, and a switching circuit 183. The AC/DC convertor 181 converts an alternating voltage supplied from a power supply to a predetermined direct voltage (24V) and outputs the predetermined direct voltage (24V). The main circuit board 170 outputs control signals to control the relay 182 and switching circuit 183, and thereby controls the heater 81A of the fixing device 80.

Electric power (3.3V) is supplied from the main circuit board 170 to the first temperature sensor S1, the sheet sensor S3, and the cam sensor S4 via the connectors 150, 160 and the intermediate circuit board 240. Electric power (1.8V) is supplied from the main circuit board 170 to the second temperature sensor S2 via the connectors 150, 160 and the intermediate circuit board 240.

Signals SG1 from the first temperature sensor S1, signals SG2 from the second temperature sensor S2, signals SG3 from the sheet sensor S3, and signals SG4 from the cam sensor S4 are output to the main circuit board 170 via the intermediate circuit board 240 and the connectors 150, 160. The sheet sensor S3 and the cam sensor S4 are connected to the ground of the main circuit board 170 via the intermediate circuit board 240 and the connectors 150, 160.

The ground of the main circuit board 170 is grounded via the low voltage power supply board 180.

The ground of the intermediate circuit board 240 is electrically continuous with the metal plate 300 of the main housing 10 via a helical compression spring 270 which will be described below, the connecting frame 230, the first side frame 210 or the second side frame 220, and one of the first bosses 120. The metal plate 300 is connected to a main housing frame ground FG. The main housing frame ground FG is made of sheet metal. The main housing frame ground FG is grounded via the low voltage power supply board 180.

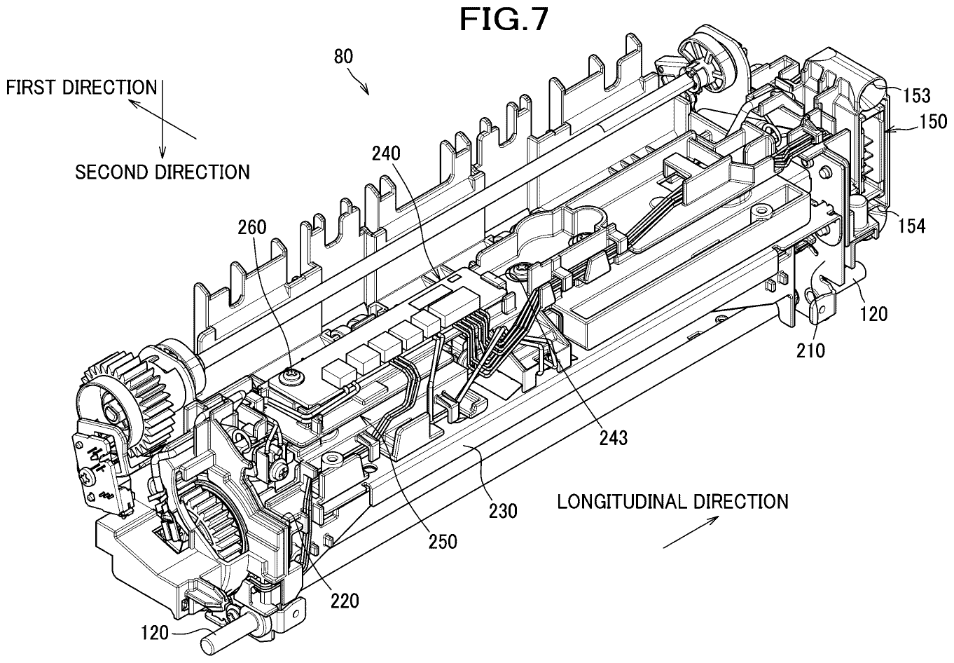

As shown in FIG. 7, the fixing device 80 further comprises a plastic frame 250 and a screw 260.

The plastic frame 250 covers the connecting frame 230. The plastic frame 250 is disposed between the intermediate circuit board 240 and the connecting frame 230. The intermediate circuit board 240 is fixed to the plastic frame 250.

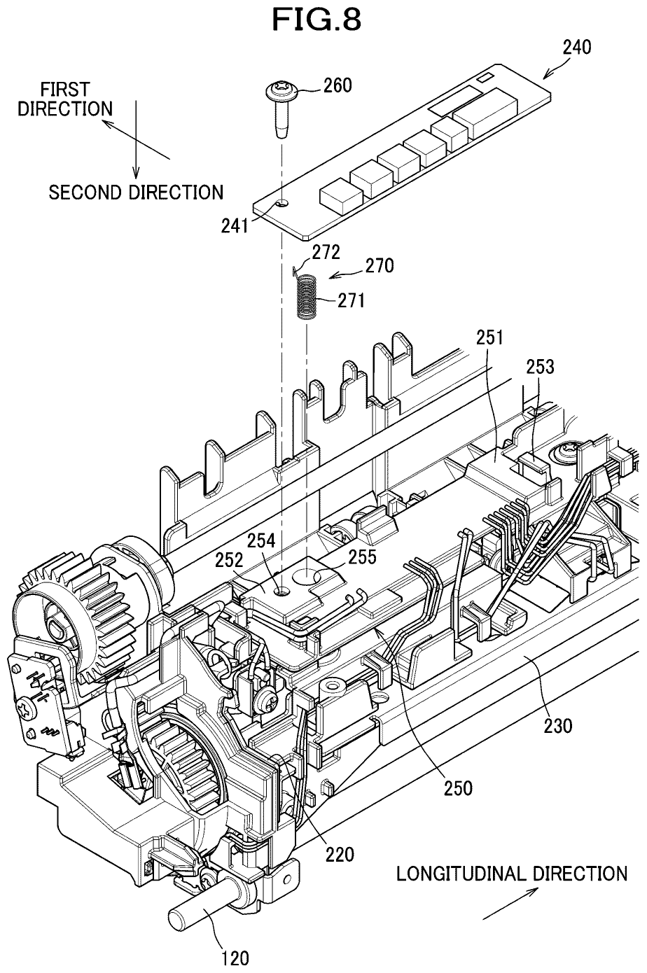

As shown in FIG. 8, the plastic frame 250 includes a first mount 251, a second mount 252, a hook 253, a first hole 254, and a second hole 255.

The first mount 251 is a trapezoidal portion supporting the first end portion of the intermediate circuit board 240. The first mount 251 protrudes toward the other side in the second direction.

The second mount 252 is a trapezoidal portion supporting the second end portion of the intermediate circuit board 240. The second mount 252 protrudes toward the other side in the second direction.

The hook 253 is engaged with the first end portion of the intermediate circuit board 240. The hook 253 extends further toward the other side in the second direction than the first mount 251 and has an end portion protruding toward the other side in the longitudinal direction.

The first hole 254 is a hole to which the screw 260 is fastened. The first hole 254 is recessed toward the one side in the second direction. The first hole 254 is provided in the second mount 252.

The second hole 255 is a hole in which the helical compression spring 270 is disposed. The second hole 255 is provided in the second mount 252 and extends through the second mount 252 in the second direction. The first hole 254 and the second hole are formed next to each other in the longitudinal direction. The second hole 255 is located between the hook 253 and the first hole 254 in the longitudinal direction.

The screw 260 fixes the intermediate circuit board 240 to the plastic frame 250. Specifically, the intermediate circuit board 240 has a through hole 241 in the second end portion thereof. The through hole 241 extends through the intermediate circuit board 240 in the second direction. The screw 260 extends through the through hole 241 of the intermediate circuit board 240 and is fastened to the first hole 254 of the plastic frame 250. The screw 260 thereby fixes the second end portion of the intermediate circuit board 240 to the plastic frame 250.

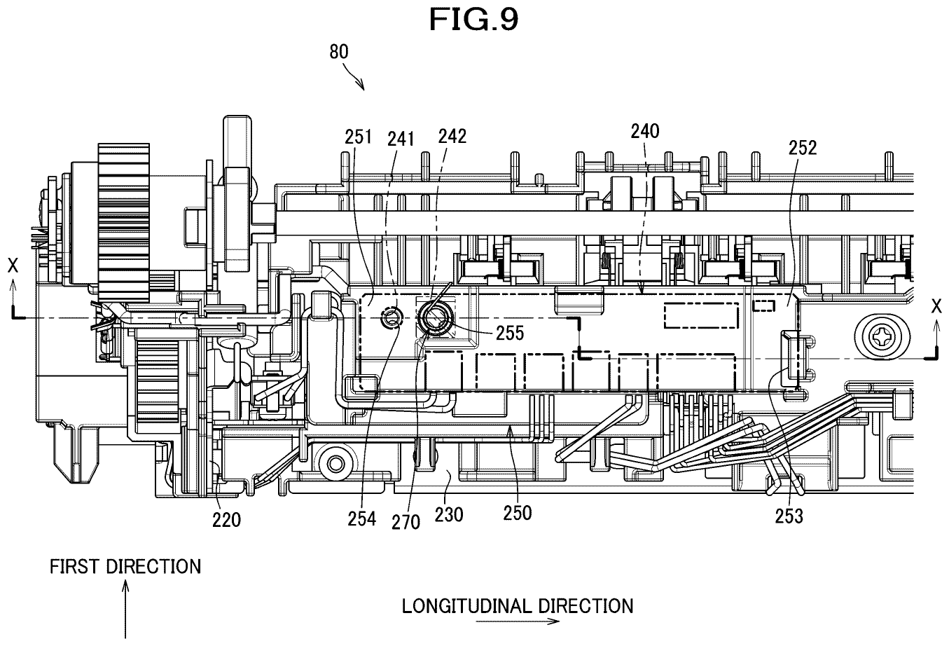

The ground of the intermediate circuit board 240 is electrically continuous with the connecting frame 230. Specifically, as shown in FIG. 9, the intermediate circuit board 240 has a circuit board ground terminal 242 shown by thin dashed-double dotted lines, on a surface facing in the one side in the second direction. The fixing device 80 further comprises a helical compression spring 270. The intermediate circuit board 240 is electrically continuous with the connecting frame 230 via the circuit board ground terminal 242 and the helical compression spring 270.

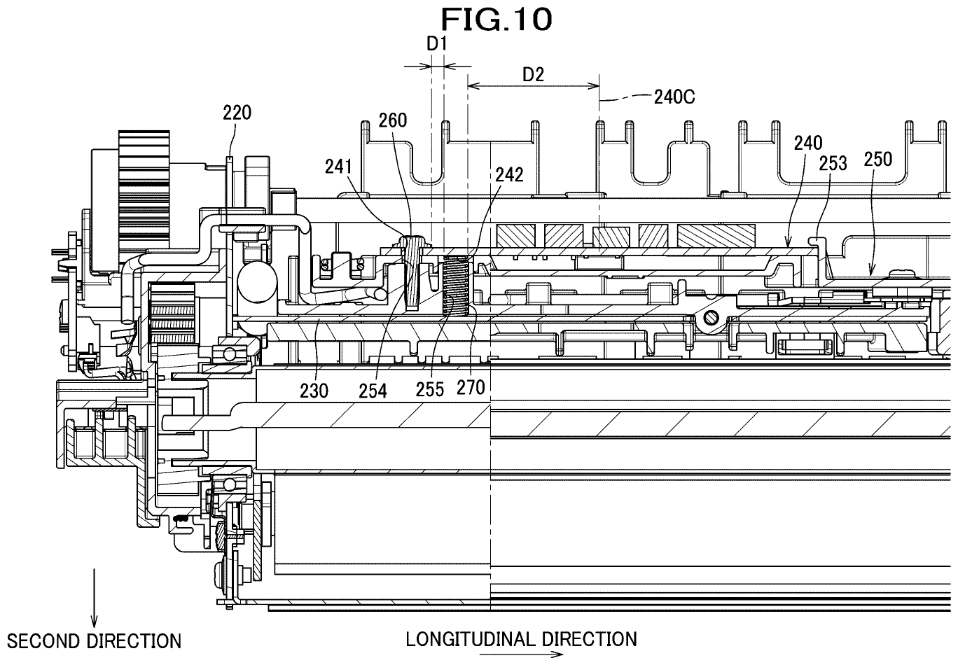

As shown in FIG. 10, the helical compression spring 270 is a metal spring that establishes electrical continuity between the ground of the intermediate circuit board 240 and the connecting frame 230. The helical compression spring 270 is disposed between the intermediate circuit board 240 and the connecting frame 230 in a compressed state. One end of the helical compression spring 270 on the one side in the second direction is in contact with the connecting frame 230. The other end of the helical compression spring 270 on the other side in the second direction is in contact with the circuit board ground terminal 242 of the intermediate circuit board 240.

The helical compression spring 270 is located between the hook 253 of the plastic frame 250 and the screw 260 in the longitudinal direction. The distance D1 from the screw 260 to the helical compression spring 270 is shorter than the distance D2 from the helical compression spring 270 to a central portion 240C of the intermediate circuit board 240 in the longitudinal direction. In other words, the helical compression spring 270 is located closer to the screw 260 than to the central portion 240C of the intermediate circuit board 240 in the longitudinal direction.

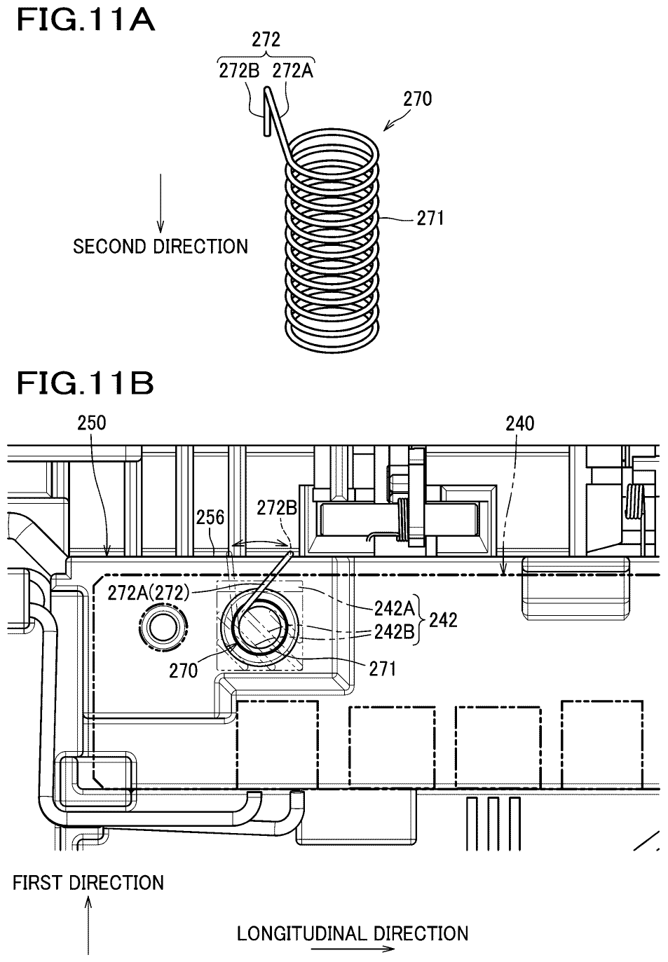

As shown in FIG. 11A, the helical compression spring 270 includes a coil 271 and an arm 272. The arm 272 extends from an end of the coil 271 on the other side in the second direction. In other words, the arm 272 extends from an end of the coil 271 located closer to the intermediate circuit board 240.

The arm 272 includes a first portion 272A and a second portion 272B. The first portion 272A extends radially outward in a radial direction of the coil 271 from the end of the coil 271 on the other side in the second direction and has a radially outer end. The second portion 272B extends toward the one side in the second direction from the radially outer end of the first portion 272A.

As shown in FIG. 11B, the arm 272 of the helical compression spring 270 is in contact with the circuit board ground terminal 242 of the intermediate circuit board 240.

Specifically, the first portion 272A of the arm 272 of the helical compression spring 270 is in contact with main terminal 242A, which will be described below, of the circuit board ground terminal 242.

The arm 272 is engaged with the plastic frame 250 and restricts the rotation of the helical compression spring 270. In more detail, the plastic frame 250 has a to-be-engaged surface 256 facing the one side in the first direction. The second portion 272B of the arm 272 is contactable with the to-be-engaged surface 256 from the one side in the first direction. The first portion 272A of the arm 272 contacts the to-be-engaged surface 256 and thereby restricts the rotation of the helical compression spring 270.

The circuit board ground terminal 242 comprises a main terminal 242A and a sub terminal 242B. The main terminal 242A is located on an end portion of the circuit board ground terminal 242 on the one side in the first direction and extends in the longitudinal direction. The sub terminal 242B is located on the other side in the first direction with respect to the main terminal 242A and extends diagonally relative to the longitudinal direction.

In this embodiment, the helical compression spring 270 is rotatable between a first contact position in which the arm 272 is shown by solid lines and a second contact position in which the arm 272 is shown by dashed-double dotted lines. The length of the main terminal 242A in the longitudinal direction is set such that the main terminal 242A contacts the first portion 272A of the arm 272 when the helical compression spring 270 is located in the first contact position and also when the helical compression spring 270 is located in the second contact position.

The sub terminal 242B is contactable with the coil 271 of the helical compression spring 270. Even when the arm 272 loses contact with the main terminal 242A for some reason, the coil 271 in contact with the sub terminal 242B allows the helical compression spring 270 to establish electrical continuity between the ground of the intermediate circuit board 240 and the connecting frame 230.

The ground of the intermediate circuit board 240 is connected to the ground of the main housing 10 via the helical compression spring 270, the connecting frame 230, the first side frame 210 or the second side frame 220, one of the first bosses 120, and one of the metal plates 300 in a state where the first bosses 120 are in contact with the metal plates 300 of the main housing 100 (see FIG. 4).

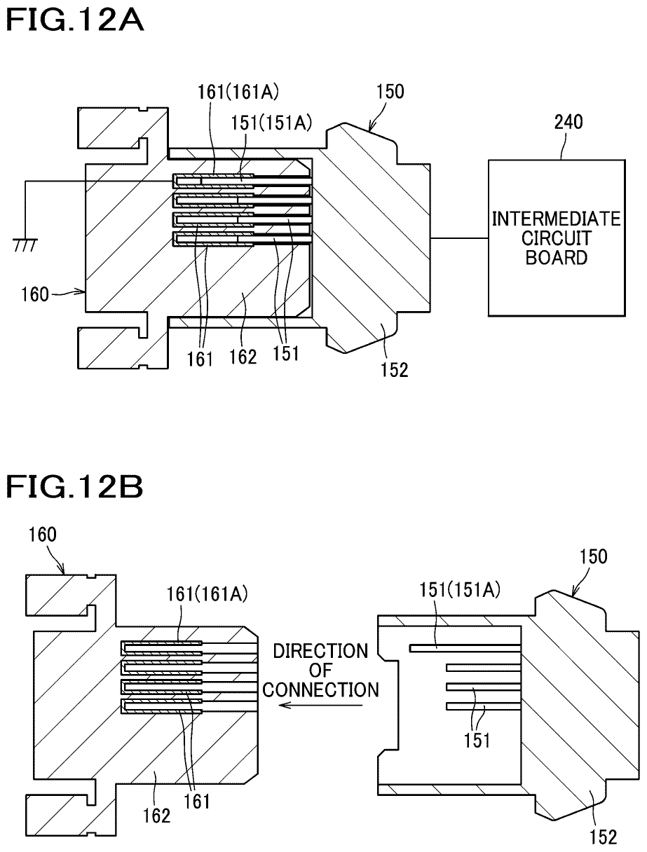

As shown in FIGS. 12A and 12B, the main housing connector 160 has a plurality of terminals 161 and a main housing connector housing 162 holding the plurality of terminals 161. The external connector 150 has a plurality of terminals 151 corresponding to the terminals 161 of the main housing connector 160 and an external connector housing 152 holding the plurality of terminals 151. The terminals 151 of the external connector 150 and the terminals 161 of the main housing connector 160 are connected when the external connector housing 152 and the main housing connector housing 162 are fitted together.

The plurality of terminals 151 of the external connector 150 include, for example, a terminal for outputting signals from the first temperature sensor S1 and a terminal for outputting signals from the second temperature sensor S2. The plurality of terminals 161 of the main housing connector 160 include, for example, a terminal to which the signals from the first temperature sensor S1 are inputted and a terminal to which the signals from the second temperature sensor S2 are inputted.

Further, the plurality of terminals 161 of the main housing connector 160 include a second ground terminal 161A, and the plurality of terminals 151 of the external connector 150 include a first ground terminal 151A. The second ground terminal 161A is connected to the ground of the main housing 10. The first ground terminal 151A is connected to the ground of the intermediate circuit board 240.

The first ground terminal 151A is connected to the second ground terminal 161A in a state where the external connector 150 is attached to the main housing connector 160. In this way, the first ground terminal 151A is connected to the ground of the main housing 10 via the second ground terminal 161A in the state where the external connector 150 is attached to the main housing connector 160.

The first ground terminal 151A protrudes further downstream in a direction of connection than the other terminals 151. The direction of connection is the direction in which the external connector 150 is moved relative to the main housing connector 160 to be attached thereto. In this embodiment, the first ground terminal 151A has a length longer in the direction of connection than the other terminals and extends further downstream in the direction of connection than the other terminals 151. Thus, when the external connector 150 is being attached to the main housing connector 160, the first ground terminal 151A is the first terminal 151 to come close to the second ground terminal 161A and the first terminal 151 to be connected to the second ground terminal 161A.

As shown in FIG. 13A, the main housing connector 160 further has a first guide pin 163 and a second guide pin 164. The main housing connector housing 162 is located between the first guide pin 163 and the second guide pin 164 in the second direction. The first guide pin 163 and the second guide pin 164 extend in the first direction. Ends of the first guide pin 163 and the second guide pin 164 are located further to the one side in the first direction than the main housing connector housing 162.

The fixing device 80 has a first guide hole 153 and a second guide hole 154. The external connector housing 152 is located between the first guide hole 153 and a second guide hole 154 in the second direction. The first guide hole 153 receives the first guide pin 163. The second guide hole 154 receives the second guide pin 164. The external connector housing 152, the first guide hole 153, and the second guide hole 154 are opened toward the other side in the first direction.

Next, connection of the intermediate circuit board 240 and the ground of the main housing 10 when the fixing device 80 is being installed into the main housing 10 will be described.

As shown in FIG. 13A, as the fixing device 80 is inserted into the main housing 10, each of the first bosses 120 of the fixing device 80 contacts the corresponding first guide surface 311 of the main housing 10 and is guided thereby.

As shown in FIG. 13B, as the fixing device 80 is inserted further into the main housing 10, the first guide hole 153 receives the first guide pin 163 and the second guide hole 154 receives the second guide pin 164. Further, each of the first bosses 120 contact the second guide surface 312 formed on the corresponding metal plate 300. In this way, the intermediate circuit board 240, which is electrically continuous with the first bosses 120, is connected to the ground of the main housing 10 via the metal plates 300 before the external connector 150 is attached to the main housing connector 160.

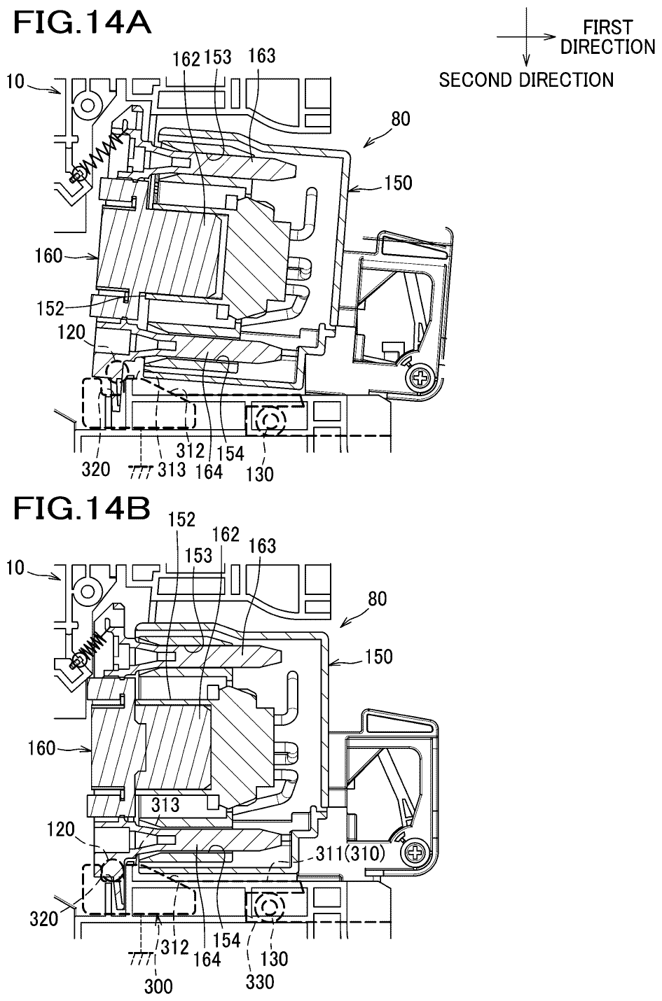

As shown in FIG. 14A, as the fixing device 80 is further inserted into the main housing 10, each of the first bosses 120 is guided by the corresponding second guide surface 312 and then guided by the corresponding third guide surface 313 in a direction along the first direction. Further, the external connector housing 152 of the external connector 150 is fitted onto the main housing connector housing 162 of the main housing connector 160 so that the terminals 151 (not shown) of the external connector 150 move into contact with the terminals 161 of the main housing connector 160.

As the fixing device 80 is further inserted into the main housing 10, each of the first bosses 120 fall off the corresponding third guide surface 313 and enter the corresponding first recess 320 as shown in FIG. 14B. In this way, the fixing device 80 is inserted into the main housing 10 and is located in place with respect to the main housing 10 in the first direction and in the second direction.

Further, the external connector housing 152 is fitted onto the main housing connector housing 162 and the external connector 150 is attached to the main housing connector 160. In this way, the first ground terminal 151A and the second ground terminal 161A (see FIG. 12A) are connected to each other and the intermediate circuit board 240 is connected to the ground of the main housing 10 also via the connectors 150, 160.

Next, advantageous effects of the present embodiment will be described.

The ground of the intermediate circuit board 240 is electrically continuous with the connecting frame 230, which is connected to the ground of the main housing 10; thus, static electricity can be dissipated via the connecting frame 230 if an electrostatic discharge occurs between the external connector 150 and the main housing connector 160 when the fixing device 80 is installed into the main housing 10. Failure of the temperature sensors S1, S2 can thereby be restrained.

The first ground terminal 151A is connected to the ground of the main housing 10 via the second ground terminal 161A in the state where the external connector is attached to the main housing connector 160; thus, the intermediate circuit board 240 can be connected to the ground of the main housing 10 via the connectors 150, 160 after the external connector 150 and the main housing connector 160 are attached.

The first ground terminal 151A protrudes further downstream than the other terminals 151 in the direction in which the external connector 150 is moved relative to the main housing connector 160 to be attached thereto; thus, static electricity can be dissipated from the first ground terminal 151A to the connecting frame 230 if an electrostatic discharge occurs between the external connector 150 and the main housing connector 160 when the fixing device 80 is installed into the main housing 10. Failure of the temperature sensors S1, S2 can thereby be restrained.

The helical compression spring 270 that establishes electrical continuity between the ground of the intermediate circuit board 240 and the connecting frame 230 is located between the intermediate circuit board 240 and the connecting frame 230; thus, electrical continuity between the ground of the intermediate circuit board 240 and the connecting frame 230 can be stabilized.

The plastic frame 250 has a hook 253 that is engaged with the first end portion of the intermediate circuit board 240, and the screw 260 fixes the second end portion of the intermediate circuit board 240 to the plastic frame 250; thus, the intermediate circuit board 240 can be easily fixed to the plastic frame 250 compared to, for example, an alternative embodiment in which both ends of the intermediate circuit board 240 in the longitudinal direction are fixed to the plastic frame 250 by screws.

The helical compression spring 270 is located between the hook 253 and the screw 260 in the longitudinal direction and the distance D1 from the screw 260 to the helical compression spring 270 is shorter than the distance D2 from the helical compression spring 270 to the central portion 240C of the intermediate circuit board 240; thus, the helical compression spring 270 can be compressed while restraining the intermediate circuit board 240 from deflecting when the intermediate circuit board 240 is fixed to the plastic frame 250 by the screw 260.

The arm 272 of the helical compression spring 270 is engaged with the plastic frame 250 and restricts the rotation of the helical compression spring 270; thus, electrical continuity between the ground of the intermediate circuit board 240 and the helical compression spring 270 can be stabilized.

The first boss 120, which is in contact with the main housing 10 to establish electrical continuity with the ground of the main housing 10 in the state where the fixing device 80 is installed in the main housing 10, is electrically continuous with the connecting frame 230; thus, electrical continuity between the connecting frame 230 and the ground of the main housing 10 can be established via the first boss 120.

Since the first boss 120 as an example of the contacting portion is a boss extending in the longitudinal direction, the fixing device 80 and the main housing 10 can be easily brought into contact.

The first boss 120 is fixed to the first side frame 210 or to the second side frame 220, both made of metal; thus, electrical continuity between the intermediate circuit board 240 and the ground of the main housing 10 can be established via the connecting frame 230, the first side frame 210 or the second side frame 220, and one of the first bosses 120.

The first boss 120 contacts the main housing 10 before the external connector 150 is attached to the main housing connector 160; thus, static electricity can be more reliably dissipated via the connecting frame 230 if an electrostatic discharge occurs between the external connector 150 and the main housing connector 160 when the fixing device 80 is installed into the main housing 10. Failure of the temperature sensors S1, S2 can thereby be further restrained.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although the connecting portion is a pair of first bosses 120 in the above-described embodiment, the connection portion may only comprise one of the bosses 120. Further, in the above-described embodiment, the intermediate circuit board 240 and the ground of the main housing 10 are electrically continuous via the first side frame 210 and the second side frame 220, to which the first bosses 120 are fixed. However, the intermediate circuit board and the ground of the main housing may be electrically continuous via one boss and the first side frame and not via the second side frame, or may be electrically continuous via one boss and the second side frame and not via the first side frame.

Although the contacting portion comprises the first bosses 120, i.e. the boss, in the above-described embodiment, the contacting portion may, for example, be an edge of at least one of the first side frame or the second side frame. In more detail, the edge of the at least one of the first side frame or the second side frame may contact the main housing and establish electrical continuity with the ground of the main housing in the state where the fixing device is installed in the main housing.

Although the connecting frame 230 is connected to the ground of the main housing 10 via the side frames 210, 220 and the first bosses 120 in the above-described embodiment, the connecting frame itself may, for example, contact the main housing and be connected to the ground of the main housing in the state where the fixing device is installed in the main housing.

In the above-described embodiment, the first end portion of the intermediate circuit board 240 is engaged with the hook 253 of the plastic frame 250 and the second end portion of the intermediate circuit board 240 is fixed to the plastic frame 250 by the screw 260. However, both end portions of the intermediate circuit board in the longitudinal direction may, for example, be fixed to the plastic frame by screws or be fixed to the plastic frame by hooks of the plastic frame.

In the above-described embodiment, the helical compression spring 270 has the arm 272 that is engaged with the plastic frame 250 to restrict the rotation of the helical compression spring 270. However, the helical compression spring 270 may not have an arm that restricts the rotation of the helical compression spring if, for example, the coil of the helical compression spring contacts the terminal of the ground of the intermediate circuit board.

In the above-described embodiment, the fixing device 80 comprises the helical compression spring 270 that establishes electrical continuity between the ground of the intermediate circuit board 240 and the connecting frame 230. However, the fixing device may, for example, comprise a spring other than the helical compression spring that establishes electrical continuity between the ground of the intermediate circuit board and the connecting frame. Further, the fixing device may, for example, not comprise a spring that establishes electrical continuity between the ground of the intermediate circuit board and the connecting frame. If the fixing device does not comprise a spring for establishing electrical continuity, the intermediate circuit board and the connecting frame may, for example, be directly in contact with each other to establish electrical continuity between the ground of the intermediate circuit board and the connecting frame.

Although the first ground terminal 151A protrudes further downstream in the direction of connection than the other terminals 151 in the above-described embodiment, a position of a downstream end of the first ground terminal may, for example, be the same as positions of downstream ends of the other terminals in the direction of connection.

Although the first temperature sensor S1 is a non-contact type thermistor in the above-described embodiment, the first temperature sensor S1 may, for example, be a contact-type thermistor. Further, although the second temperature sensor S2 is a contact-type thermistor in the above-described embodiment, the second temperature sensor S2 may, for example, be a non-contact type thermistor. At least one of the first temperature sensor or the second temperature sensor may be a temperature sensor other than a thermistor.

Although the heating member 81 comprises a heater 81A and a heating roller 81R in the above-described embodiment, the heating member may, for example, comprise a heater and an endless belt that rotates around the heater. In other words, although the heating roller 81R is given as an example of the heating rotator in the above-described embodiment, the heating rotator may comprise an endless belt. Further, although the pressure member 82 comprises a pressure roller 82R in the above-described embodiment, the pressure member may, for example, comprise an endless belt and a pad that faces an inner surface of the belt and holds the belt in combination with the heating roller. In other words, although the pressure roller 82R is given as an example of the pressure rotator in the above-described embodiment, the pressure rotator may comprise an endless belt.

Although the heating roller 81R receives a driving force from a driving source in the above-described embodiment, the pressure roller may receive a driving force from a driving source and the heating roller may be driven by the pressure roller.

Although the image forming apparatus 1 is a color printer capable of forming a multicolor image in the above-described embodiment, the image forming apparatus may, for example, be a monochrome printer capable of forming only a monochrome image. Further, the image forming apparatus may, for example, be a copying machine, a multifunction machine, etc.

The elements described in the above-described embodiment and its modified examples may be implemented selectively and in combination.

What is claimed is:

1. A fixing device installable into a main housing of an image forming apparatus, the fixing device comprising:
a heating rotator extending in a longitudinal direction;
a pressure rotator extending in the longitudinal direction and configured to nip a sheet in combination with the heating rotator;
a first temperature sensor configured to detect a temperature of the heating rotator;
a second temperature sensor configured to detect a temperature of the heating rotator, the second temperature sensor being located at a position different from a position at which the first temperature sensor is located in the longitudinal direction;
an external connector connectable to a main housing connector of the main housing;
an intermediate circuit board configured to:
relay a signal from the first temperature sensor to the external connector; and
relay a signal from the second temperature sensor to the external connector;
a first side frame located on one side in the longitudinal direction with respect to the heating rotator;
a second side frame located on another side in the longitudinal direction with respect to the heating rotator; and
a connecting frame connecting the first side frame and the second side frame, the connecting frame being made of metal and connected to a ground of the main housing,
wherein a ground of the intermediate circuit board is electrically continuous with the connecting frame.

2. The fixing device according to claim 1, wherein
the external connector comprises a first ground terminal,
the main housing connector comprises a second ground terminal connected to the ground of the main housing, and
the first ground terminal is connected to the ground of the main housing via the second ground terminal in a state where the external connector is attached to the main housing connector.

3. The fixing device according to claim 2, wherein
the external connector comprises another terminal in addition to the first ground terminal, and
the first ground terminal protrudes further downstream than the another terminal, in a direction in which the external connector is moved relative to the main housing connector to be attached thereto.

4. The fixing device according to claim 1, further comprising a helical compression spring disposed between the intermediate circuit board and the connecting frame to establish electrical continuity between the ground of the intermediate circuit board and the connecting frame.

5. The fixing device according to claim 4, further comprising:
a plastic frame disposed between the intermediate circuit board and the connecting frame; and
a screw that fixes the intermediate circuit board to the plastic frame.

6. The fixing device according to claim 5, wherein
the intermediate circuit board is elongated in the longitudinal direction and has:
a first end portion on the one side in the longitudinal direction; and
a second end portion on the another side in the longitudinal direction,
the plastic frame includes a hook configured to be engaged with the first end portion of the intermediate circuit board, and
the screw fixes the second end portion of the intermediate circuit board to the plastic frame.

7. The fixing device according to claim 6, wherein
the helical compression spring is located between the hook and the screw in the longitudinal direction, and
a distance from the screw to the helical compression spring is shorter than a distance from the helical compression spring to a central portion of the intermediate circuit board in the longitudinal direction.

8. The fixing device according to claim 5, wherein
the helical compression spring includes:
a coil; and
an arm extending from an end of the coil located closer to the intermediate circuit board, and
the arm is configured to be engaged with the plastic frame to restrict rotation of the helical compression spring.

9. The fixing device according to claim 1, further comprising a contacting portion configured to contact the main housing and establish electrical continuity with the ground of the main housing in a state where the fixing device is installed in the main housing, the contacting portion being electrically continuous with the connecting frame.

10. The fixing device according to claim 9, wherein the contacting portion is a boss made of metal, the boss extending in the longitudinal direction.

11. The fixing device according to claim 10, wherein
the first side frame is made of metal, and
the boss is fixed to the first side frame.

12. The fixing device according to claim 9, wherein when the fixing device is being installed into the main housing, the contacting portion is configured to contact the main housing and establish electrical continuity with the ground of the main housing before the external connector is attached to the main housing connector.

13. An image forming apparatus comprising:
a main housing;
a process unit comprising a photosensitive drum, the process unit being installable into the main housing;
an exposure device configured to expose the photosensitive drum; and
a fixing device installable into the main housing,
wherein the fixing device comprises:
a heating rotator extending in a longitudinal direction;
a pressure rotator extending in the longitudinal direction and configured to nip a sheet in combination with the heating rotator;
a first temperature sensor configured to detect a temperature of the heating rotator;
a second temperature sensor configured to detect a temperature of the heating rotator, the second temperature sensor being located at a position different from a position at which the first temperature sensor is located in the longitudinal direction;
an external connector connectable to a main housing connector of the main housing;
an intermediate circuit board configured to:
relay a signal from the first temperature sensor to the external connector; and
relay a signal from the second temperature sensor to the external connector;
a first side frame located on one side in the longitudinal direction with respect to the heating rotator;
a second side frame located on another side in the longitudinal direction with respect to the heating rotator; and
a connecting frame connecting the first side frame and the second side frame, the connecting frame being made of metal and connected to a ground of the main housing, wherein a ground of the intermediate circuit board is electrically continuous with the connecting frame.

14. The image forming apparatus according to claim 13, wherein
the external connector comprises a first ground terminal,
the main housing connector comprises a second ground terminal connected to the ground of the main housing, and
the first ground terminal is connected to the ground of the main housing via the second ground terminal in a state where the external connector is attached to the main housing connector.

15. The image forming apparatus according to claim 14, wherein
the external connector comprises another terminal in addition to the first ground terminal, and
the first ground terminal protrudes further downstream than the another terminal, in a direction in which the external connector is moved relative to the main housing connector to be attached thereto.

16. The image forming apparatus according to claim 13, wherein the fixing device further comprises a contacting portion configured to contact the main housing and establish electrical continuity with the ground of the main housing in a state where the fixing device is installed in the main housing, the contacting portion being electrically continuous with the connecting frame.

17. The image forming apparatus according to claim 16, wherein the contacting portion is a boss made of metal, the boss extending in the longitudinal direction.

18. The image forming apparatus according to claim 17, wherein
the first side frame is made of metal, and
the boss is fixed to the first side frame.

19. The image forming apparatus according to claim 16, wherein when the fixing device is being installed into the main housing, the contacting portion is configured to contact the main housing and establish electrical continuity with the ground of the main housing before the external connector is attached to the main housing connector.
